(19) United States
(12) Patent Application Publication
(10) Pub. No.: US 2022/0174163 A1
(43) Pub. Date: Jun. 2, 2022

(54) INFORMATION PROCESSING DEVICE, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Masafumi KAWAGUCHI, Nagoya (JP)

(21) Appl. No.: 17/536,390

(22) Filed: Nov. 29, 2021

(30) Foreign Application Priority Data
Nov. 30, 2020 (JP) 2020-198012

(51) Int. Cl. H04N 1/00

(52) U.S. Cl. CPC H04N 1/00464; H04N 2201/0094; H04N 1/00503; H04N 1/0097

(57) ABSTRACT

A memory of a PC stores a setting application and a browser, and an MFP includes an EWS and is configured to provide a EWS page. A CPU of the PC receives a customization instruction of the EWS page through a user IF with using a setting application and stores the customization instruction. Further, when receiving a displaying instruction of the EWS page, the CPU accesses the EWS page of the MFP through a communication IF, receives a web page, generates a customized web page by applying the customization setting stored in the storing to the web page received in the receiving, and displays the customized web page on the user interface by executing the browser.

### CROSS-REFERENCE TO RELATED APPLICATIONS

This application claims priority under 35 U.S.C. § 119 from Japanese Patent Application No. 2020-198012 filed on Nov. 30, 2020. The entire subject matter of the application is incorporated herein by reference.

### BACKGROUND

The present disclosures relate to an information processing device configured to perform setting of an image processing device, and a non-transitory computer-readable recording medium containing computer-executable instructions realizing a program to be installed in the image processing device.

Conventionally, there have been known technologies of customizing a screen displayed on a user interface of an image processing device such as a printer from an external device via a network are known. An example of such a technology is configured to remotely customize a screen displayed by a user interface of a multifunctional peripheral (MFP) equipped with a user interface from a management terminal.

### SUMMARY

In recent years, there has been known a technology in which an image processing system is equipped with an embedded web server (EWS), which is a program to make the image processing system function as a web server, and the settings of the image processing system can be configured from an information processing device such as a PC via a web page provided by the EWS. In this case, by enabling customization of the EWS web page, it is possible to provide a setting screen that matches the user's preference. However, in the case of a system in which multiple users are expected to use the image processing equipment, even if it is suitable for one user, it is not necessarily suitable for other users.

According to aspects of the present disclosures, there is provided an information processing device, comprising a communication interface, a user interface, a memory, and a computer. The memory including a non-transitory computer-readable recording medium containing first instructions realizing an image processing program having a function of requesting an image processing device to perform image processing, and second instructions realizing a browser having a function of displaying a web page on the user interface, the image processing device having an embedded web server functioning as a web server, the embedded web server being configured to provide the web page configured to receive settings of the image processing device. The first instructions, when executed by the computer, causes the information processing device to perform receiving, through the user interface, a customization setting of the web page provided by the embedded web server, storing the customization setting received in the receiving. When the computer receives a display instruction of the web page provided by the embedded web server through the user interface, the second instructions, when executed by the computer, causes the information processing device to perform accessing the embedded web server of the image processing device through the communication interface, receiving the web page from the embedded web server, generating a customized web page by applying the customization setting stored in the storing to the web page received in the receiving, and displaying the customized web page on the user interface by executing the browser.

### BRIEF DESCRIPTION OF THE DRAWINGS

FIG. 1 is a block diagram showing an electrical configuration of an image processing system.

FIG. 2 shows an example of an EWS page.

FIG. 3 shows another example of the EWS page.

FIG. 4 is a sequence chart illustrating procedures to store customization information.

FIG. 5 shows an example of a screen through which a customization instruction is received.

FIG. 6 shows an example of the EWS page after customization.

FIG. 7 is an example of a sequence chart illustrating an EWS page displaying procedure.

FIG. 8 is another example of a sequence chart illustrating the EWS page displaying procedure.

FIG. 9 is a further example of a sequence chart illustrating the EWS page displaying procedure.

### DETAILED DESCRIPTION

Hereinafter, an image processing system 100 according to an embodiment of the present disclosures will be described in detail below with reference to the accompanying drawings. The image processing system 100 includes a personal computer (hereinafter referred to as a “PC”) and a multifunctional peripheral (hereinafter referred to as an “MFP”).

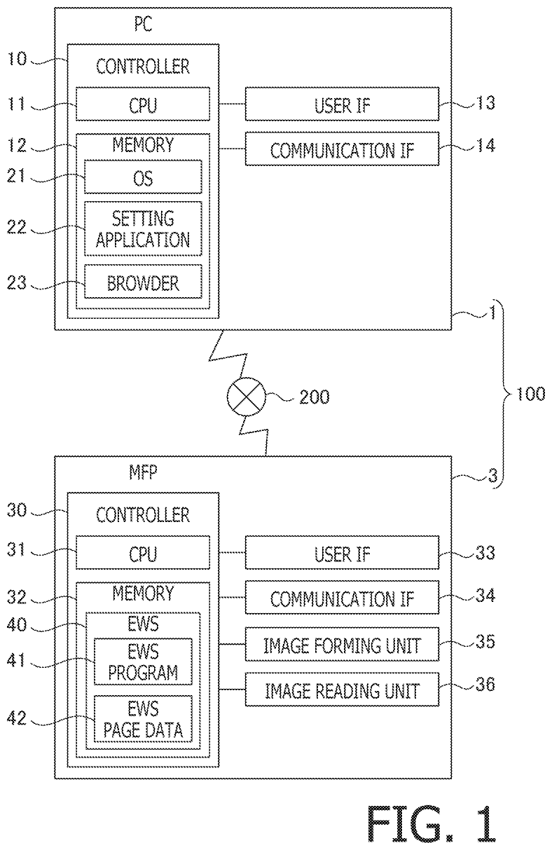

As shown in FIG. 1, the image processing system 100 according to the present embodiment includes a PC 1 and an MFP 3, each of which can be connected to the Internet 200. The PC 1 is an example of an information processing device, and the MFP 3 is a device configured to perform various image processing functions such as printing and scanning The MFP 3 is an example of an image processing device.

The PC 1 according to the present embodiment has a controller 10 including a CPU 11 and a memory 12, as shown in FIG. 1. The CPU 11 is an example of a computer. The PC 1 is also provided with a user interface (hereinafter referred to as a “user IF”) 13 and a communication interface (hereinafter referred to as a “communication IF”) 14, which are electrically connected to the controller 10.

The CPU 11 is configured to execute various processes in accordance with programs read from the memory 12 and/or based on user operations. Various programs and various data are stored in the memory 12, including an operating system (hereinafter referred to as an “OS”) 21, an application program for setting MFP information (hereinafter referred to as a “setting application”) 22, and a browser 23, as shown in FIG. 1. The memory 12 is also used as a work area when various processes are executed. A buffer provided by the CPU 11 is also serves as an example of memory.

The OS 21 is, for example, Windows®, macOS®, Linux®, iOS®, or Android®. The setting application 22 is a program that has a function to request the MFP 3 to perform processes. It is noted that the setting application 22 is an example of an image processing program. The details of the setting application 22 will be described later. A browser 23 is a program that displays a web page on the user IF 13.

The user IF 13 includes hardware for displaying a screen for informing the user of information and hardware for receiving operations by the user. The user IF 13 may be a combination of a display capable of displaying information and a mouse, keyboard and the like with an input receiving function. The user IF 13 may be a touch panel with a display function and an input receiving function.

The communication IF 14 includes at least a configuration for connecting to the Internet 200, and includes hardware for communicating with external devices such as the MFP 3. The communication standard of the communication IF 14 is Ethernet®, Wi-Fi®, or the like. The PC 1 may be equipped with a plurality of communication IFs 14 respectively corresponding to a plurality of communication standards.

As shown in FIG. 1, the MFP 3 according to the present embodiment has a controller 30 including a CPU 31, a memory 32, and the like. The MFP 3 is also provided with a user IF 33, a communication IF 34, an image forming unit 35, and an image reading unit 36, which are electrically connected to the controller 30. The controllers 10 and 30 in FIG. 1 are generic terms for the hardware and software used to control the PC 1 and MFP 3, and do not necessarily represent a single piece of hardware that actually exists in the PC1 and MFP 3.

The CPU 31 is configured to execute various processes in accordance with programs read from the memory 32 and/or based on the user's operations. The memory 32 stores various programs and various data including an embedded web server (hereinafter referred to as an “EWS”) 40. The EWS 40 is a set of programs for making the MFP 3 function as a web server, and includes, for example, an EWS program 41 and EWS page data 42. One example of the memory 12 and 32 is not limited to a ROM, a RAM, an HDD, and the like built into the PC 1 and the MFP 3, but may also be a storage medium that is readable and writable by the CPU 11 and 31, such as a CD-ROM, a DVD-ROM, and the like.

The user IF 33 includes hardware for displaying a screen to notify information and hardware for receiving operations by the user. The user IF 33 may be a touch panel equipped with a display function and an operation receiving functions, or a combination of a display with a function to display information and buttons or the like to receive input operations.

The communication IF 34 includes a configuration capable of connecting to at least the Internet 200, and includes hardware for communicating with external devices such as the PC 1. The communication standard of the communication IF 34 is the Ethernet, the Wi-Fi, and the like. The MFP 3 may be provided with a plurality of communication IFs 34 respectively corresponding to a plurality of communication standards.

An image forming unit 35 includes a configuration for printing an image based on image data on a printing medium such as a sheet. The image forming method of the image forming unit 35 is, for example, an electrophotographic method or an inkjet method. The image reading unit 36 includes a configuration for reading an image of an original document and obtaining image data.

The MFP 3 according to the present embodiment functions as a web server that provides web pages by communicating with an external device according to the HTTP protocol through the EWS 40. Concretely, the MFP 3 has the EWS program 41 resident and monitors reception of HTTP requests. When the MFP 3 receives an HTTP request, the MFP 3 generates a web page in an HTML format based on the EWS page data 42, and transmits an HTTP response containing the generated web page data to the device from which the HTTP request was received.

For example, when a URL corresponding to the EWS 40 of the MFP 3 is designated in the browser 23, the PC 1 accesses the EWS 40 via the communication IF 14 and transmits an HTTP request to the MFP 3. Based on the HTTP response received from the MFP 3, the PC 1 displays a web page on the user IF by the browser 23. In the following description, the HTTP request transmitted to the MFP 3 is referred to as an “EWS request,” and the web page provided by the EWS 40 of the MFP 3 and displayed by the PC 1 on the user IF 13 is referred to as an “EWS page.”

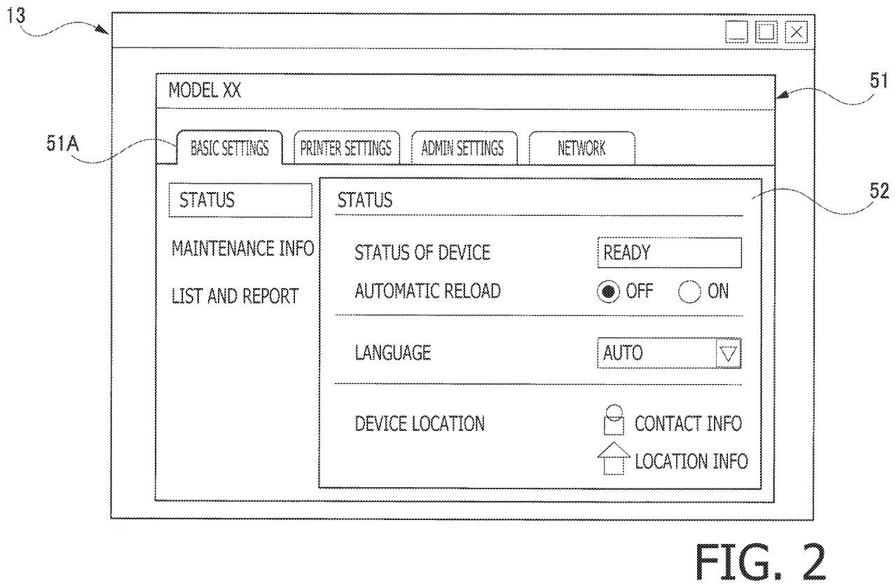

When the MFP 3 according to the present embodiment receives the EWS request from the PC 1, the MFP 3 transmits the page data of the EWS page, including, for example, the status of the MFP 3, maintenance information, and usage status, to the PC 1. The browser 23 of PC 1 displays the EWS page on the user IF 13 based on the received page data. As shown in FIG. 2, for example, the MFP 3 according to the present embodiment has page data including status information 52 of the MFP 3 of model XX as the original EWS page (hereinafter referred to as an “original page”) 51. This status information 52 includes, for example, information on the items of “device status,” “language,” and “device location.”

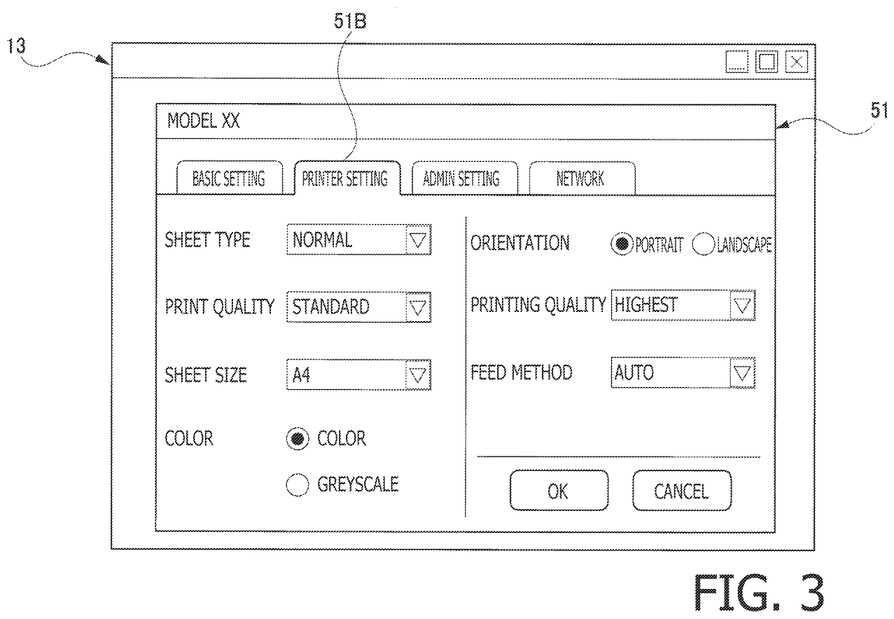

The original page 51 has multiple tabs, as shown in FIG. 2, and by receiving operations on the tabs, the PC 1 switches the contents to be displayed. FIG. 2 shows a state where a Basic Settings tab 51A is selected. When the operation, by the user, to the Printer Settings tab 51B is received, the PC1 displays a page to receive various settings related to printing of the MFP 3, as shown in FIG. 3.

The EWS page contains items that can receive input operations by the user. For example, in the original page 51, each print setting item such as the “language” item in the Basic Settings tab 51A shown in FIG. 2 and the paper type, paper size, and the like in the Printer Settings tab 51B shown in FIG. 3 are items that can be selected by the user of PC 1. When the browser 23 of the PC1 receives an operation of a receivable item of the EWS page being displayed, the browser 23 transmits the setting contents based on the received input operation to the MFP 3 corresponding to the EWS page which is being displayed. The MFP 3 is configured based on the settings received in the EWS page. The EWS page may also receive changes to network information, changes to scanning settings, and the like.

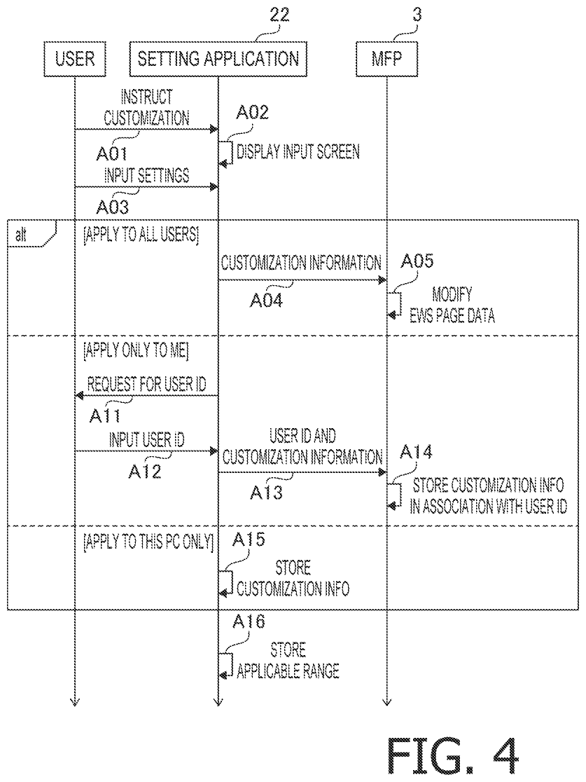

The PC 1 according to the present embodiment, for example, receives instructions for customizing the display form of the EWS page by the setting application 22. A process when the instructions for customizing the EWS page are received will be described with reference to a sequence chart shown in FIG. 4. It is noted that each of the following processes and each processing step basically indicates the processing of the CPU 11 and the CPU 31 according to the instructions described in the program. In the following description, the operation of each program is described with omitting description of an operation of the OS. In addition, the processing of the CPUs 11 and 31 according to the instructions in the program may be expressed with omitting the CPU.

As shown in FIG. 4, the user starts the setting application 22 and inputs an instruction to start the process of customizing the EWS page in the setting application 22 (A01). When the setting application 22 receives the instruction to start customization, the setting application 22 displays an input screen to receive the user's input in the user IF 13 (A02).

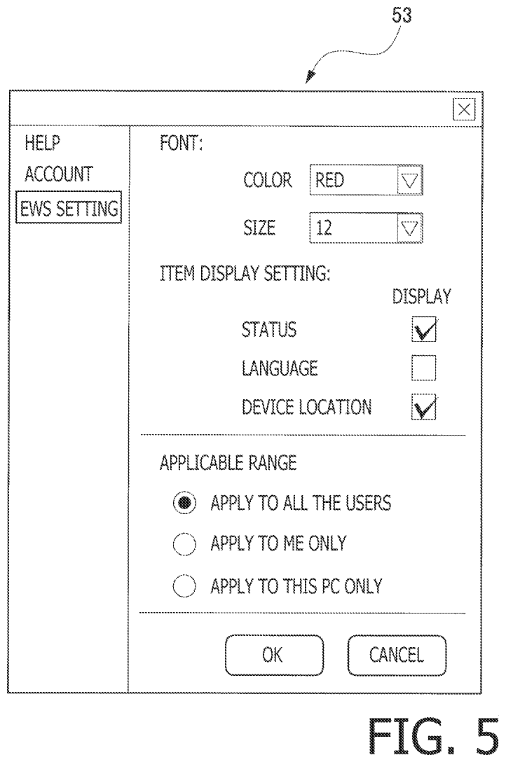

For example, as shown in FIG. 5, the input screen 53 displays selection candidates of font type, font size, font color, and choices of display or non-display for each item in the display of each item name included in the status information 52 as the selection candidates of custom display settings for each item included in the EWS page. In the original page 51 according to the present embodiment, a character string indicating an item name is displayed in blue characters of 11.5 points, for example. The options for displaying the item name may include, for example, “Do not change,” “Undo,” and so on. The setting application 22 may further receive instructions for selecting a background, changing the icon, and the like.

The user selects a preferred display format on the displayed input screen 53 and sets the same by operating an OK button (A03). It is noted that A03 is an example of a receiving process. FIG. 5 shows an example in which the color and size of the character string of the item name is changed, the status and device location are displayed, and the language item is not displayed.

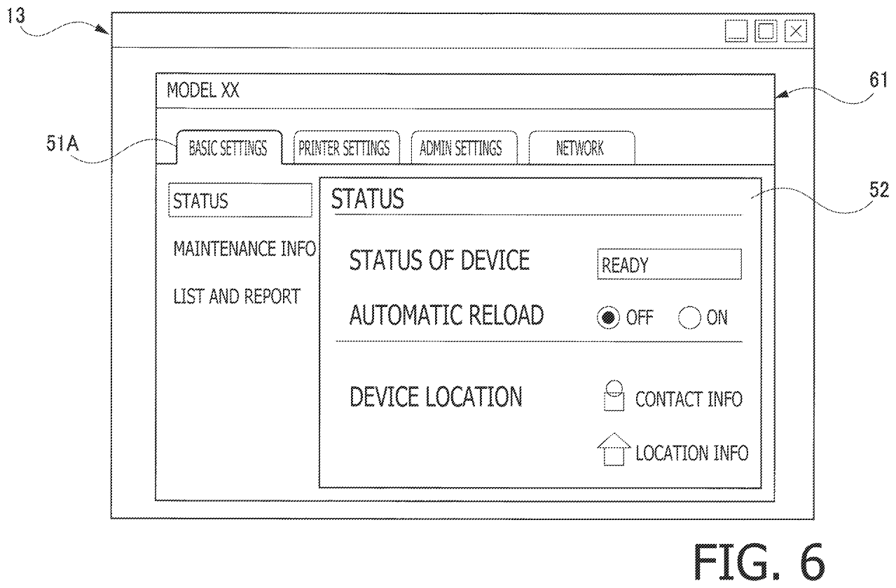

For example, when an EWS page is customized according to the settings shown in FIG. 5, the EWS page is changed from the original page 51 illustrated in FIG. 2 to a customized EWS page (hereinafter referred to as a “custom page”) 61 in the form shown in FIG. 6. Concretely, in the custom page 61, the text string indicating the item name is displayed in 12-point red characters. It is noted that, in the drawing, the difference in the size of the text is exaggerated. Among the three items included in the original page 51, the “language” item is not included in the custom page 61. The custom page 61 is an example of a custom web page.

In A03, the setting application 22 also receives the selection of the applicable range of customization instructions through the input screen 53. Concretely, as shown in FIG. 5, the setting application 22 receives one of following three options of “Apply to all users,” “Apply to me only,” and “Apply to this PC only.” The item “Apply to all users” is an example of a second method of custom setting, and the items “Apply to me only” and “Apply to this PC only” are examples of a first method of custom setting. It is noted that A03, which receives the selection of the applicable range, is an example of a selection process.

When the item “Apply to all users” is selected, regardless of the user, and regardless of the device transmitting the EWS request, the custom page 61 will be displayed when the EWS page is displayed. For example, when a particular user selects the item “Apply to all users” on PC 1 and gives customization instructions, the custom page 61 will be displayed even if another user displays the EWS page on another PC.

On the other hand, when the item “Apply to me only” is selected, for example, based on the user ID, the custom page 61 is displayed for display instructions by the user who gave the customization instructions, and the original page 51 is displayed for display instructions by other users. If the item “Apply to this PC only” is selected, for example, based on the device identification, the custom page 61 is displayed for display instructions received by the PC 1 regardless of the user, and the original page 51 is displayed for display instructions received by other devices (i.e., the custom page 61 is not displayed on displays of the other devices).

Then, the setting application 22 determines whether the item “Apply to all users” is selected in the customization instructions on the input screen 53. When it is determined that the item “Apply to all users” is selected (alt: [Apply to all users]), the setting application 22 transmits the customization information, which is information indicating the instructions selected on the input screen 53, to the MFP 3 (A04). The customization information is an example of a custom setting. The MFP 3 modifies the EWS page data 42 stored in the memory 32 based on the received customization information, and stores the modified EWS page data 42 in the memory 12 (A05).

The customization information is, for example, information that is represented by a CSS (Cascading Style Sheet). When the CSS is incorporated into the page data, the display form of the page is changed according to the CSS. With use of the CSS, the web page is customized by incorporating the CSS that contains the customization information. Therefore, the customization is easier than when the web page is directly rewritten based on the customization information. The customization information can be any information that can be used in the process of changing the page data based on the user's designation, and is not necessarily limited to the CSS.

On the other hand, when it is determined that the item “Apply only to me” has been selected (alt: [Apply to only me]), the setting application 22 requests the user to input the user ID (A11). The user inputs the user ID via the user IF 13 (A12). The user ID is identification information that identifies the user, e.g., a user name, an employee number, and the like. When the OS 21 has the information of the user ID, e.g., as the user has logged in to the PC 1 when starting to use the PC 1, the setting application 22 may obtain the information of the user ID from the OS 21 instead of executing A11 and A12. The setting application 22 transmits the received information of the user ID and the customization information to the MFP 3 (A13). When the MFP 3 receives the combination of the user ID and the customization information, the MFP 3 stores the customization information in the memory 32 (A14) in association with the user ID. In this way, the customization information is stored in association with the user.

When it is determined that the item “Apply to this PC only” has been selected (alt: [Apply to this PC ONLY]), the setting application 22 stores the customization information in the area available to the setting application 22 in the memory 12 of PC 1 (A15). It is noted that A14 and A15 are examples of a saving process.

Further, the setting application 22 stores the information on the applicable range of the customization instructions in the area available to the setting application 22 in the memory 12 of the PC 1 (A16). The above is the description of the process when the instruction to customize the EWS page is accepted.

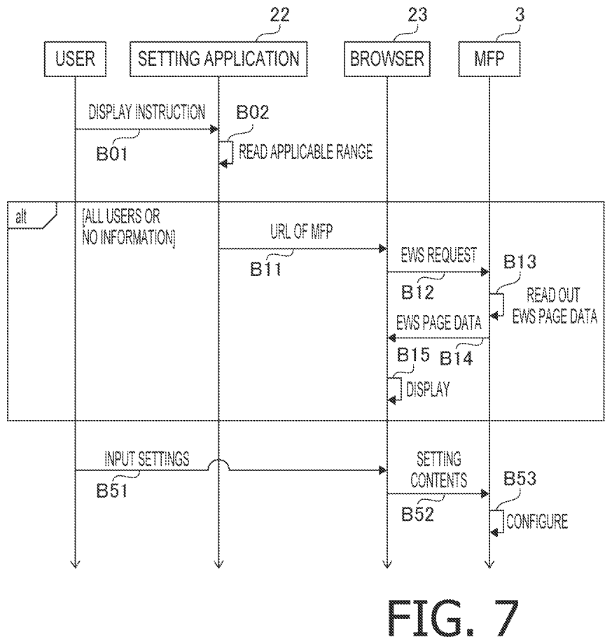

Next, a process when an instruction to display an EWS page is received after executing the process shown in the sequence diagram of FIG. 4 will be described with reference to the sequence charts shown in FIGS. 7 to 9. The PC 1 according to the present embodiment, for example, receives an instruction to display the EWS page by the setting application 22. This process is executed after the customization instruction is received and the EWS page data 42 has been changed in A05 of FIG. 4, or the customization information is stored in the PC 1 or the MFP 3 in either A14 or A15. FIGS. 7 to 9 each shows a process in which the aforementioned customization instructions are applied in different ranges, and common procedures thereamong are indicated by the same reference symbols/numerals.

As commonly shown in FIGS. 7 to 9, the user starts the setting application 22 and enters the instruction to display the EWS page in the setting application 22 (B01). The setting application 22 reads the information on the applicable range from the memory 12 (B02). The applicable range information is the information stored in memory 12 at A16 in FIG. 4, and is not stored in memory 12 when no customization instructions are received by the user, i.e., when the process shown in FIG. 4 is not executed.

When the setting application 22 determines that the information of the applicable range is “Applicable to all users” or that the information of the applicable range is not stored (alt: [All users or No information] in FIG. 7), the setting application 22 passes the URL corresponding to the EWS 40 of the MFP 3 to the browser 23 (B11). The setting application 22 obtains the URL of the EWS 40 in advance and stores the same in the memory 12. The setting application 22 may obtain the URL of the EWS 40, for example, by communication with the MFP 3 or by user input.

The browser 23 transmits the EWS request to the MFP 3 based on the passed URL (B12). When the MFP 3 receives the EWS request, the MFP 3 reads the EWS page data 42 from the memory 32 (B13) as described above, and transmits the read page data to the PC 1 from which the EWS request was received (B14). The browser 23 transmits the received page data to the PC 1, the device from which the EWS request was received (B14). The browser 23 displays the EWS page on the user IF 13 based on the received page data (B15).

When the applicable range is “Apply to all users,” then according to A05 in FIG. 4, the EWS page data 42 stores the page data of custom page 61 to which the customization information has been applied. Therefore, the EWS page data 42 read in B13 is the page data of the custom page 61, and in B15, the custom page 61 is displayed. On the other hand, when the information on the applicable range is not stored, that is, when the customization instruction is not received, the EWS page data 42 stores the page data of the original page 51 that has not been customized Therefore, the EWS page data 42 read out in B13 is the page data of the original page 51, and in B15, the original page 51 is displayed.

Through the displayed EWS page, the PC 1 receives the settings of the MFP 3 by the user. In other words, the user can use the EWS page to make, for example, print settings for the MFP 3. The browser 23 receives the user's setting input in the web page displayed on the user IF 13 (B51). Based on the received setting input, the browser 23 transmits the setting contents to the MFP 3 (B52). The MFP 3 configures its own settings based on the received setting contents (B53).

When the item “Apply to all users” is selected, the EWS page data 42 stored in the MFP 3 is directly changed, and thus a custom page 61 is displayed in response to an instruction to display an EWS page, regardless of the user or PC. Therefore, for example, when the MFP 3 is used by multiple users from multiple devices, and it is desired to display the custom page 61 regardless of who displays the same on which PC, the customization is applied to all users and PCs by giving the customization instructions on one PC, thus reducing the customization effort. For example, by customizing a given item not to be displayed, it is possible to prevent each user from changing the settings for that item. It may be configured such that only an administrator can select the item “Apply to all users.”

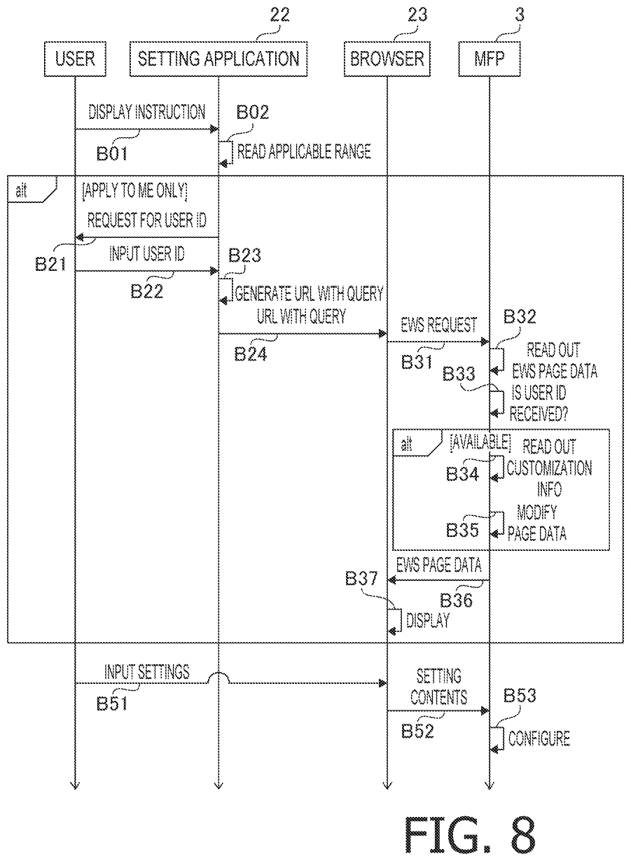

On the other hand, when the setting application 22 determines that the range of application information obtained in B02 is the item “Apply to me only” (alt: [Apply to me only] in FIG. 8), the setting application 22 requests the user to input the user ID (B21), as shown in FIG. 8. Then, the user enters the user ID via the user IF 13 (B22). The setting application 22 may obtain the information of the user ID from the OS 21. The setting application 22 adds the received information of the user ID as a query to the URL of the EWS 40 to generate a URL with query (B23), and passes the generated URL with the query to the browser 23 (B24).

The browser 23 transmits an EWS request to the MFP 3 based on the URL with the query received (B31). When the MFP 3 receives the EWS request, the MFP 3 reads the EWS page data 42 from the memory 32 (B32). Further, the MFP 3 determines whether the user ID received as a query is stored in the memory 32 in association with the customization information (B33). The customization information and the user ID are the information stored in the memory 32 by the MFP 3 in A14 of FIG. 4.

When it is determined that the user ID is stored (alt: [Yes]), the MFP 3 reads the customization information stored in association with the user ID (B34), and modifies the EWS page data 42 read in B32 using the read customization information (B35). Further, the MFP 3 transmits the modified EWS page data 42 to PC 1 (B36). When the MFP 3 determines that the user ID included in the query is not stored in the memory 32, the MFP 3 does not execute B34 and B35, and in B36, the MFP 3 transmits the EWS page data 42 read in B32 to the PC 1 without changing the same.

The browser 23 receives the page data from the MFP 3 and displays the EWS page on the user IF 13 based on the received page data (B37). As a result, the custom page 61 is displayed when it is a display instruction by the user who has stored the customization information, and the original page 51 is displayed when it is a display instruction by another user. It is noted that B37 is an example of a display process.

When the item “Apply only to me” is selected, the customization information is stored in the MFP 3, and the page data is changed in the MFP 3, so the processing load on PC 1 is small Further, since the customization information is stored for each user, different customizations can be made for each user even when the same PC is used to display the EWS page. In addition, even if the EWS page is displayed on a device other than the customized PC 1, the same custom page 61 can be displayed for the same user.

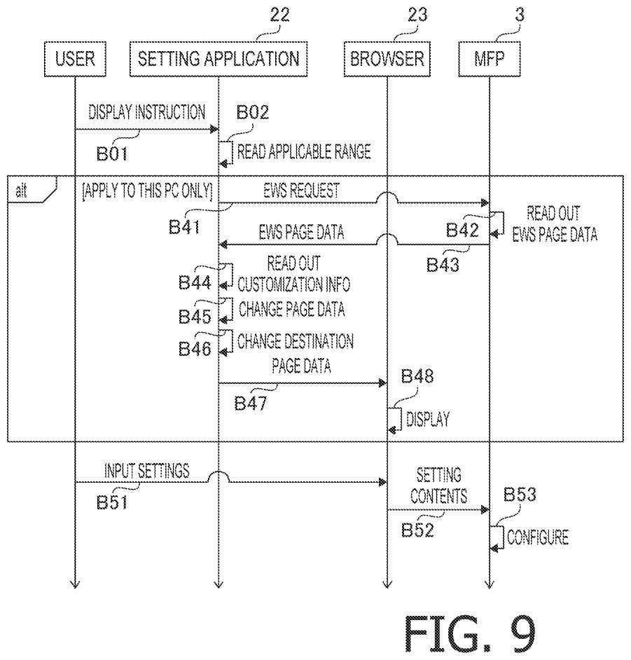

When the setting application 22 determines that the information of the applicable range obtained in B02 is “Applicable to this PC only” (alt: [this PC] in FIG. 9), the setting application 22 transmits an EWS request directly from the setting application 22 to the MFP 3 using the URL of the EWS 40 as shown in FIG. 9 (B41). When the MFP 3 receives the EWS request, the MFP 3 reads the EWS page data 42 from the memory 32 (B42) and transmits the read page data to the PC 1 (B43). In this case, in the PC 1, the setting application 22, not the browser 23, transmits the EWS request and receives the EWS page data 42.

The setting application 22 reads the customization information from the memory 12 (B44). This customization information is the information that the setting application 22 stored in the memory 12 in A15 of FIG. 4. Further, the setting application 22 changes the page data obtained in B43 using the customization information read in B44 (B45). Further, the setting application 22 changes the destination of the settings received in the EWS page to the MFP 3 (B46).

Then, the setting application 22 passes the changed page data to the browser 23 (B47), and the browser 23 displays the EWS page on the user IF 13 based on the received page data (B48). This causes the custom page 61 to be displayed on the user IF 13. B48 is an example of the display process.

Normally, when the browser 23 receives page data and displays a web page, the browser 23 automatically sets the destination of the information based on the input operation on the web page to the device that has passed the page data of the web page to the browser 23. For example, when the page data is received from the MFP 3 in B14 of FIG. 7 or B36 of FIG. 8, the browser 23 transmits the setting contents to the MFP 3 based on the setting input received on the page which is being displayed (B51 and B52 in FIG. 7 and FIG. 8).

On the other hand, in a case where the page data is received from the setting application 22 in B47 of FIG. 9, when the destination is not changed in B46, the browser 23 passes the setting contents to the PC 1 and does not transmit the same to the MFP 3. In the present embodiment, by changing the destination in B46, the setting contents based on the setting input received in B51 are transmitted to the MFP 3 in B52. Then, the MFP 3 can configure its own device in B53 based on the received setting contents.

When the item “Apply to this PC only” is selected, the processing load of MFP3 is small because the customization information is stored in the PC 1 and the page data is changed in the PC 1. Further, since the customization can be done for each PC, for example, the customization of one PC does not affect the display on other PCs, and the customization can be done according to the performance of the user IF 13. In addition, since the processing on the MFP 3 side is simply to read and transmit the EWS page data 42, as in the conventional configuration, the customization is highly versatile. When the PC is shared by multiple users, the customization information can be stored in association with the user ID information for each user, and the customization can be applied to each user. In this way, it is possible to display a web page that suits each user's preference.

As explained in detail above, according to the setting application 22 according to the present embodiment, when the PC 1 receives an instruction for customization, the PC 1 stores the customization information, and when the PC 1 receives an instruction for displaying a custom page 61, which is an EWS page reflecting the stored customization information, the custom page 61 is displayed by the browser 23. Thus, for example, by storing the customization information that suits the preferences of each user, it is possible to provide EWS pages that are suitable for respective users.

It is noted that the configuration of the above-described embodiment is merely an example and does not limit aspects of the present disclosures in any way. Therefore, the technology disclosed herein can naturally be improved and modified in various ways within aspects of the present disclosures but not deviating therefrom. For example, an example of the image processing device is not necessarily limited to an MFP, but aspects of the present disclosures are applicable to any device equipped with an image processing function and an EWS function, such as a general home or office printer, a scanner, a sewing machine, a label printer, an industrial printer, a 3D printer, and a machine tool that performs processing according to image data.

The screens illustrated in the embodiment are all examples, and the arrangement of each screen and the wording included therein are not necessarily limited to those shown in the drawings. For example, when multiple MFPs or other devices are connected to the PC 1, the setting application 22 may also receive the selection of the device to be customized

According to the present embodiment, the selection from three types of applicable ranges is received, but the configuration is not necessarily limited to that disclosed in the embodiment. For example, the selection may be made from two types, or only one type.

When the item “Apply only to me” is selected as the applicable range, the setting application 22 may receive the selection not to enter the user ID in B22 of FIG. 8. In such a case, the setting application 22 can pass the URL without the query added thereto to the browser 23. In this way, the original page 51 will be displayed by the same process as is performed in B12 to B15 of FIG. 7, and the user who has not given instructions for customization can reduce the time and effort of entering the user ID.

When the item “Apply to this PC only” is selected as the applicable range, the setting application 22 stores the customization information in the PC 1. The configuration may be changed such that the customization information is stored in the MFP 3 in association with the information of the PC 1. For example, instead of A15 of FIG. 4, the identification information of the PC 1 and the customization information may be transmitted to the MFP 3, and these information may be stored in the MFP 3 in an associated manner As the identification information of the PC 1, the IP address or the MAC address can be used. When receiving an instruction to display an EWS page, the setting application 22 may be configured to pass an EWS request with the identification information of the PC added as a query to the browser 23, as in B23 of FIG. 8. In this way, the MFP 3 can still display the EWS page customized for each PC by applying the customization information based on the identification information of the PC.

In the embodiment, it is assumed that the destination is changed in B46 of FIG. 7, but it is not necessary. That is, the setting contents received in the EWS page may be stored in the setting application 22, and then, transmitted from the setting application 22 to the MFP 3 in response to the receipt of a transmission instruction by the user.

In any sequence chart disclosed in the embodiment, the plurality of processes in any multiple steps can be arbitrarily changed in the order of execution or executed in parallel, to the extent that there is no contradiction in the processing contents.

The processes disclosed in the embodiment may be executed by a single CPU, multiple CPUs, hardware such as an ASIC, or a combination thereof. In addition, the processes disclosed in the embodiment may be realized in various forms, such as a non-transitory recording medium containing computer-executable instructions (i.e., program) causing, when executed, an MFP to perform the processes.

What is claimed is:

1. An information processing device, comprising:
a communication interface;
a user interface;
a memory; and
a computer,
wherein the memory including a non-transitory computer-readable recording medium containing first instructions realizing an image processing program having a function of requesting an image processing device to perform image processing, and second instructions realizing a browser having a function of displaying a web page on the user interface, the image processing device having an embedded web server functioning as a web server, the embedded web server being configured to provide the web page configured to receive settings of the image processing device,
wherein the first instructions, when executed by the computer, causes the information processing device to perform:
receiving, through the user interface, a customization setting of the web page provided by the embedded web server;
storing the customization setting received in the receiving, and
wherein, when the information processing device receives a display instruction of the web page provided by the embedded web server through the user interface, the second instructions, when executed by the computer, causes the information processing device to perform:
accessing the embedded web server of the image processing device through the communication interface;
receiving the web page from the embedded web server;
generating a customized web page by applying the customization setting stored in the storing to the web page received in the receiving; and
displaying the customized web page on the user interface by executing the browser.

2. The information processing device according to claim 1,
wherein the first instructions, when executed by the computer, causes the information processing device to further perform:
in the storing, storing the customization setting received in the receiving in the memory of the information processing device;
in the displaying, reading out the customization setting stored in the memory in the storing, accessing the embedded web server of the image processing device, receiving the web page from the embedded web server, generating the customized web page reflecting the read-out customization setting based on the received web page, and displaying the customized web page on the user interface.

3. The information processing device according to claim 2,
wherein the customized web page is generated such that a destination of setting contents received as settings of the image processing device is the image processing device.

4. The information processing device according to claim 1,
wherein the first instructions, when executed by the computer, causes the information processing device to further perform:
in the storing, transmitting the customization setting received in the receiving to the image processing device in association with identification information, and causing the image processing device to store the customization setting in association with one of the information processing device and a user using the information processing device by causing the image processing device to store the customization setting in association with the identification information;
in the displaying, accessing the embedded web server of the image processing device through the communication interface and transmitting the identification information to the embedded web server, thereby causing the embedded web server to generate the customized web page reflecting the customization setting associated with the received identification information and transmit the generated customized web page to the information processing device; and
in the displaying, receiving the customized web page reflecting the customization setting associated with the identification information from the embedded web server, and displaying the received customized web page on the user interface.

5. The information processing device according to claim 1,
wherein the first instructions, when executed by the computer, causes the information processing device to further perform:
receiving selection, regarding the customization setting, one of a first method and a second method through the user interface,
wherein the first instructions, when executed by the computer, causes the information processing device to further perform:
after the receiving of the selection, determining which of the first method and the second method is selected in the receiving of the selection;
when it is determined that the first method is selected, performing the storing; and
when it is determined that the second method is selected, not performing the storing but transmitting the customization setting received in the receiving of the selection to the image processing device through the communication interface, the image processing device changing the web page provided by the embedded web server to the customized web page reflecting the received customization setting, and
wherein the first instructions, when executed by the computer, causes the information processing device to further perform:
when the computer receives the display instruction through the user interface, determining which of the first method and the second method is selected in the receiving of the selection;
when it is determined that the first method is selected, performing the displaying; and
when it is determined that the second method is selected, not performing the displaying but accessing the embedded web server of the image processing device through the communication interface, receiving the customized web page from the embedded web server, and displaying the received customized web page on the user interface by executing the browser.

6. The information processing device according to claim 1,
wherein the first instructions, when executed by the computer, causes the information processing device to further perform:
in the storing, storing a cascading style sheet indicating the customization setting received in the receiving of the customization setting, the customized web page being generated by incorporating the stored cascading style sheet into the web page.

7. A non-transitory computer-readable recording medium for an information processing device having a communication interface, a user interface, a memory, and a computer,
wherein the recording medium containing computer-executable instructions which cause, when executed by the computer, the information processing device to perform:
receiving a customization setting of a web page provided by an embedded web server through the user interface, the embedded web server being incorporated in an image processing device and provide the web page configured to receive settings of the image processing device,
storing the customization setting received in the receiving, and
when receiving a display instruction to display the web page provided by the embedded web server through the user interface:
accessing the embedded web server of the image processing device through the communication interface;
receiving the web page from the embedded web server;
generating a customized web page by applying the customization setting stored in the storing to the web page received in the receiving; and
displaying the customized web page on the user interface by executing a browser incorporated in the information processing device.

8. The recording medium according to claim 7,
wherein the instructions further cause, when executed by the computer, the information processing device to perform:
in the storing, storing the customization setting received in the receiving in the memory of the information processing device;
in the displaying, reading out the customization setting stored in the memory in the storing, accessing the embedded web server of the image processing device, receiving the web page from the embedded web server, generating the customized web page reflecting the read-out customization setting based on the received web page, and displaying the customized web page on the user interface.

9. The recording medium according to claim 7,
wherein the instructions further cause, when executed by the computer, the information processing device to perform:
in the storing, transmitting the customization setting received in the receiving to the image processing device in association with identification information, and causing the image processing device to store the customization setting in association with one of the information processing device and a user using the information processing device by causing the image processing device to store the customization setting in association with the identification information;
in the displaying, accessing the embedded web server of the image processing device through the communication interface and transmitting the identification information to the embedded web server, thereby causing the embedded web server to generate the customized web page reflecting the customization setting associated with the received identification information and transmit the generated customized web page to the information processing device; and
further in the displaying, receiving the customized web page reflecting the customization setting associated with the identification information from the embedded web server, and displaying the received customized web page on the user interface.
